(19) United States
(12) Patent Application Publication
(10) Pub. No.: US 2011/0134245 A1
(43) Pub. Date: Jun. 9, 2011

(54) Compact intelligent surveillance system comprising intent recognition

(75) Inventor: Vitaliy Khizhnichenko, Irvine, CA (US)

(73) Assignee: Irvine Sensors Corporation, Costa Mesa, CA (US)

(21) Appl. No.: 12/928,083

(22) Filed: Dec. 1, 2010

Related U.S. Application Data
(60) Provisional application No. 61/283,565, filed on Dec. 7, 2009.

(51) Int. Cl. H04N 7/18

(52) U.S. Cl. 348/148; 348/E07.085

(57) ABSTRACT

An intelligent surveillance system is disclosed for the identification of suspicious behavior near the exterior of a vehicle. The system of the invention is comprised of a “fish-eye” visible camera imaging system installed on the interior ceiling of an automobile for the 360-degree imaging and observation of the lower hemisphere around the perimeter of the vehicle. The camera of the system is augmented with an embedded processor based on DSP (digital signal processor) or FPGA (field-programmable gate array) technology to provide for the automatic detection of suspicious/hostile activities around the vehicle. The system is preferably provided with wireless transmitter means for alerting a person (e.g. the owner) of detected suspicious behavior.

### CROSS-REFERENCE TO RELATED APPLICATIONS

This application claims the benefit of U.S. Provisional Patent Application No. 61/283,565, filed on Dec. 7, 2009, entitled “Compact Intelligent Surveillance System” pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of intelligent video surveillance. More specifically, the invention relates to an image acquisition and processing surveillance system and method comprising motion analysis of images for the identification of suspicious behavior of one or more subjects in the system's field of view.

2. Description of the Related Art

Perimeter surveillance, particularly in the vicinity of stationary or moving vehicles has numerous applications in both the military and civilian sectors. Vehicular perimeter surveillance objectives include increased situational awareness for support of combat or patrol activities and civilian vehicle theft protection.

Perimeter surveillance for vehicles has unique requirements and differs from surveillance in or around for instance, open space or stationary objects such as power plants, water supplies, bridges and infrastructure or enterprise facilities.

Significant differences in the requirements between vehicular perimeter surveillance and other surveillance applications include higher compactness owing to the limited interior space of a vehicle and increased ruggedness due to environmental, temperature and mechanical stresses encountered in automotive applications. Further, the need exists for 360-degree perimeter observation with a limited field of view when only vehicle windows are available for image acquisition from an imaging device disposed within the interior of the vehicle. Finally, a vehicular perimeter surveillance system desirably includes enhanced image intelligence, i.e., the system should automatically detect suspicious/hostile activities around the vehicle and notify the responsible person (e.g. the car owner) such as by a mobile phone alert, or audible or visual alarm.

With respect to current perimeter surveillance applications, there are several systems on the market but which are mainly intended for operator viewing. One prior art system is manufactured by Sentry 360 Security Inc. and comprises one or more compact omni-view cameras (FS-IP3000/5000) installed on walls and ceilings and which is limited to motion detection capability.

Another existing system, the OmniEye camera from Genex Technologies, Inc., provides 360-degree surveillance, but the OmniEye Viewer software platform provides limited basic capabilities, e.g., operator panoramic viewing, graphic object (rectangle, ellipse) detection, pan-tilt-zoom control.

Yet a further existing surveillance system is the Smart Optical Sensor (SOS) architecture from Genex Technologies, Inc. which is mainly intended for deployment on multiple forward-looking cameras in a distributed network setting and which provides “target detection, motion tracking, and object classification and recognition”.

All of the above prior art surveillance systems are poorly-suited for applications such as vehicle surveillance where compactness is of prime importance and because the capabilities of the aforementioned systems don't include intelligent features such as automatic detection of hazardous or suspicious activities around stationary or moving vehicles.

There currently exist several intelligent video analytics desktop software products directed toward distributed surveillance systems such as those installed in office and production facilities, crowded areas, etc. but these systems are unable to satisfy the hardware constraints inherent to compact vision systems for use in automobiles.

2. Existing prior art systems include embedded video analytics systems such as ObjectVideo OnBoard (from ObjectVideo Inc.), which is embedded into the Texas Instruments DSP series TI DM64x (including DaVinci), or. Ioimage Video Analytics using DSPs. Such systems assertedly permit a user to “intelligently discern objects of interest; distinguish between humans, vehicles and other objects; and continuously track positions for all moving and stationary targets”. This embedded software usually performs relatively simple “rule-based” functions.

Unfortunately, none of the prior art systems referred to above provide 360-degree surveillance under automotive-specific constraints with automatic suspicious/hostile intent recognition.

The device and method of the invention herein addresses the above requirements and deficiencies in the prior art by providing a compact, rugged 360-degree vehicle surveillance system with intelligent suspicious behavior/intent recognition.

### BRIEF SUMMARY OF THE INVENTION

In a preferred embodiment, the system of the invention is comprised of a “fish-eye” visible camera imaging system installed on the interior ceiling of an automobile for the 360-degree imaging and observation of the lower hemisphere around the perimeter of the vehicle. The camera of the system is augmented with an embedded processor based on DSP (digital signal processor) or FPGA (field-programmable gate array) technology to provide for the automatic detection of suspicious/hostile activities around the vehicle. The system is preferably provided with wireless transmitter means for alerting a person (e.g. the owner) of detected suspicious behavior.

In a first aspect of the invention, an intelligent imaging device is provided comprising a 360-degree view, fish-eye lens electronic imaging system for acquiring an image in a predetermined range of the electromagnetic spectrum. The imaging system is disposed in the interior of a vehicle. Images are acquired by the system through at least one vehicle window and for generating an image data frame from the image. The system further comprises image processing means for receiving and processing the image data frames wherein the image processing means comprises an algorithm for generating a predetermined output when a predetermined data pattern is identified from the image data frames.

In a second aspect of the invention, a method for identifying a predetermined human behavior is provided comprising the steps of acquiring a first source image data frame and a second source image data frame, subtracting the first source image data frame from the second source image data frame to define a difference frame, binarizing the difference frame using a predetermined threshold value to generate at least one image blob and identifying motion saliency from the binarized difference frame by using a blob growing process to enable identification of predetermined (e.g., “suspicious”) movements based on analysis of kinematics of image.blobs featuring human bodies as seen through, for instance, car side windows.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIGS. 1 and 2 are graphical illustration of view geometries of the invention from above and behind a vehicle,.respectively.

FIG. 3 is a representative 360-degree image frame from the imager of the invention.

FIG. 4 depicts the representative field of view of the invention superimposed on to the image frame of FIG. 3.

FIG. 5 is an exemplar image frame with three moving subjects around the perimeter of a vehicle.

FIG. 6 is a difference frame calculated from the image frame of FIG. 5.

FIG. 7 illustrates the identification of loitering by one of the subjects of FIG. 5 and passing by two of the subjects in FIG. 5

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE INVENTION

Turning now to the figures wherein like numerals define like elements among the several views, a compact intelligent surveillance system comprising intent recognition for the identification of suspicious or other predefined behavior patterns is disclosed.

Intent Recognition Algorithm

The intent recognition algorithm of the invention is generally comprised of two parts: 1) motion saliency detection and, 2) suspicious behavior identification.

The motion saliency detection element is based on differential video frame processing, and the suspicious behavior identification element employs analysis of the motion saliency detection results to identify suspicious behavior.

The photogrammetric model below underlies the calculations as discussed further below.

Photogrammetric Model

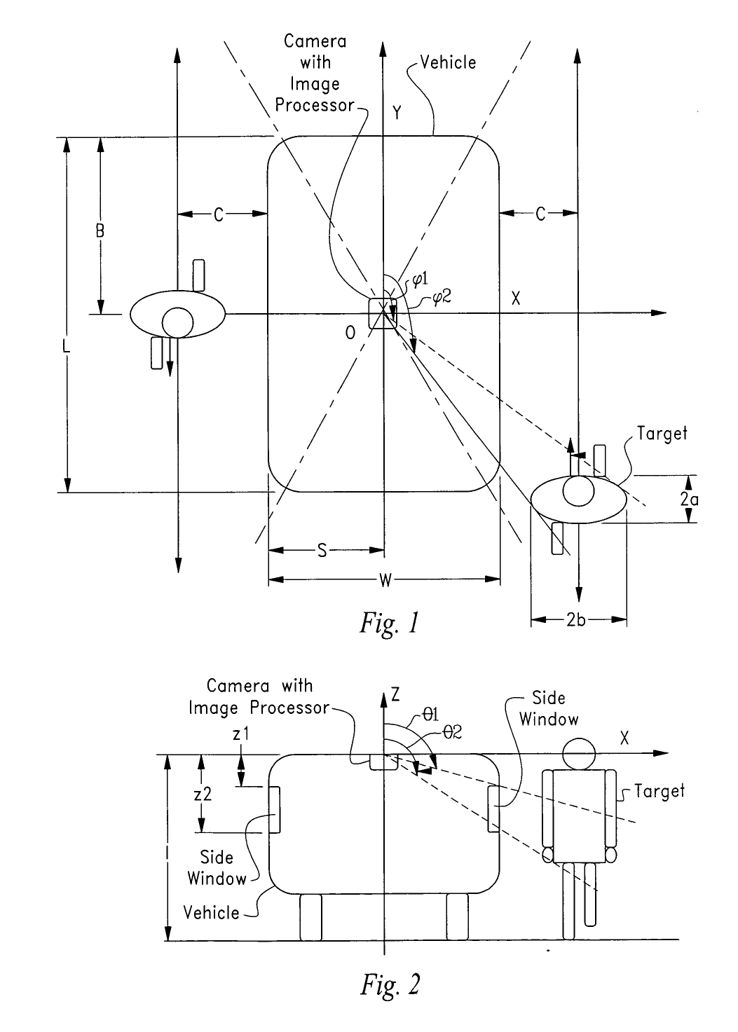

The photogrammetric model of the invention is used to determine the angular and special relationships used for the invention's imaging geometry characterization. The basic geometries of a preferred embodiment of the invention are schematically depicted in FIG. 1 and FIG. 2. For the sake of simplicity, the illustration reflects an automobile with a rounded rectangle shape and has side windows of about the same height throughout the length of the vehicle.

A ground-fixed coordinate system OXYZ is as depicted in FIG. 1 and FIG. 2, i.e., point 0 is placed onto the camera lens image plane center so that the center is located at height H above the ground. Axis OZ is directed vertically upright, axis OY is directed to the front end of the car along its central line, axis OX complements system OXYZ to be the right-handed one.

In the spherical polar coordinates r,θ,φ as they are defined in FIG. 1 and FIG. 2, every point in the space is presented as:

x=r sin θ sin φ

y=r sin θ cos φ

z=r cos θ (Eq. 1)

In the illustrated embodiment of FIG. 1 and FIG. 2, elevation angle θ is constrained by the car side window size so that for every azimuth angle φ, there are a pair of angles θ1(φ) and θ2(φ) limiting the vertical coverage of the system camera. When passing a stationary car, a person maintains a reasonable distance to the side of the vehicle defined by a distance C in FIG. 1. A human body can be characterized by its sagittal and coronal sizes in a transverse plane cross-section placed in its abdomen area. The shape in this cross-section may be approximated by an ellipse with the letter “a” and the letter “b” half-axes as reflected in FIG. 1.

Next, the projection of coordinates x,y,z is defined into pixel coordinates in an image acquired by the system camera. Taking into account the fisheye lens imaging properties and the relative position of the camera sensor array relative to the lens, the coordinate transform formulae is:

n=n₀−q(π−|θ|) cos q

m=m₀+q(π−|θ|) sin φ′ (Eq. 2)

where n,m are pixel coordinates—image matrix rows and columns, respectively; coefficient q is defined as:

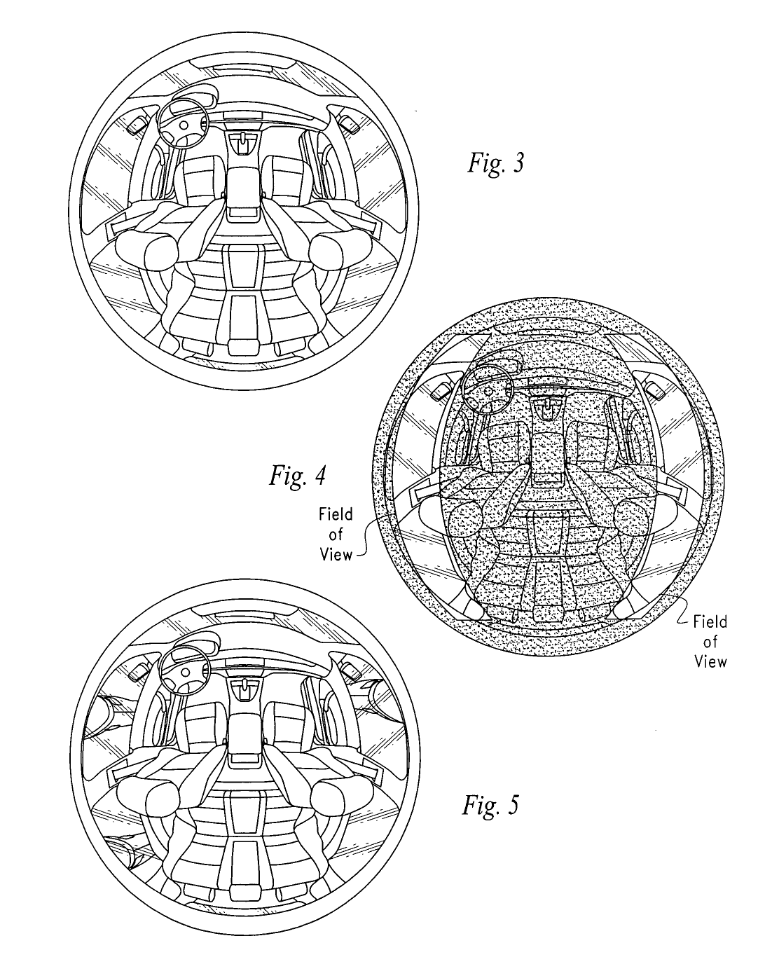

q=D/Θ,

where D is the diameter of the circle circumscribing the image data in the frame (see 360-degree image example of FIGS. 3); and Θ is the full fisheye lens coverage in elevation angle θ (it can be different from π).

Reversing the formulae from (Eq. 1), the following is obtained:

θ=tan⁻¹(\sqrt{x²+y²}/z)

φ=tan⁻¹(x/y) (Eq. 3)

Substituting expressions for θ and φ from (Eq. 3) into (Eq. 2) gives the final functions n,m from x,y,z.

From this, the right and left fields of view (FOV) can be determined—areas on the image frame where the beam bundles passing from outside the car through its side windows are projected as well as “regions of interest” (ROI)—minimal rectangles covering the projections of human bodies moving or standing near the car.

The ROI calculations are next performed—as can be seen from FIG. 1 and FIG. 2 and formulae (Eq. 2), both angles φ1,φ2 and θ1,θ2, delimit the visibility of a human body from the fisheye camera and define the size of an ROI in coordinates x,y.

Knowing the car length and width denoted as L and W in FIG. 1, respectively, and the distances between the lens image plane center to the car bumper (B) and to its left side (S), the following relations for angles φ1, φ2 are calculated based on the condition that the delimiting central beams, starting from point O at these angles, coincide with the tangent lines to the ellipse:

y_{c}±b\sqrt{1−(x_{1,2}−x_{c})²/a²}=x_{1,2} cot φ_{1,2}

∓b(x_{1,2}−x_{c})/(a²\sqrt{1−(x_{1,2}−x_{c})²/a²}=cot φ_{1,2}′ (Eq. 4)

where x_{c},y_{c} are the coordinates of the ellipse center and x_{1,2} are the x-coordinates of the tangent points on the ellipse. Note that the second equation in (Eq. 4) is obtained by differentiating the first one on x. To get the coordinates of the tangent points, a simple relation is used:

y_{1,2}=x_{1,2} cot φ_{1,2}. (Eq. 5)

The solution to the system of equations (Eq. 4) is shown to be:

$${x}_{1 , 2} = {x}_{c} + {v}_{1 , 2} \\ {ϕ}_{1 , 2} = {tan}^{- 1} ( \frac{a \sqrt{1 - {v}_{1 , 2}^{2}}}{{bv}_{1 , 2}} ) , where \\ {v}_{1 , 2} = \frac{- {x}_{c} / a \pm ( {y}_{c} / b ) \sqrt{{( {x}_{c} / a )}^{2} + {( {y}_{c} / b )}^{2} - 1}}{{( {x}_{c} / a )}^{2} + {( {y}_{c} / b )}^{2}} . \qquad ( Eq . 6 )$$

Because vision geometry is different on the right and left sides of the car, the following relations for φ1,φ2 are relevant for the right side:

φ₁=ATAN2(a\sqrt{1−v₁²,}bv₁)

φ₂=ATAN2(a\sqrt{1−v₁²,}−bv₂) (Eq. 7)

and the left side:

φ₁=ATAN2(−a\sqrt{1−v₁²,}bv₁)

φ₂=ATAN2(−a\sqrt{1−v₁²,}−bv₂)′ (Eq. 8)

where ATAN2( . . . ) is a function well known in all the major programming languages such as C/C++, Matlab, Java etc.

For either car side, there can be four combinations of angles φ1 ,φ2 and vertical coordinates z1,z2 of the side window upper/lower edges (see FIG. 1), so that the four θ angles are defined as follows:

θ_{1,2,3,4}=ATAN2(A, z_{1,2}·|sin φ_{1,2}|), (Eq. 9)

where A=W−S for the right side and A=−S for the left side.

Substituting the above values for angles φ and θ into Eq. 2 and finding minimal and maximal values for n,m, one arrives at ROIs R (interpreted here as 4-dimensional vectors) depending on coordinates x_{c},y_{c}:

R(x_{c},y_{c})≡{nₘᵢₙ(x_{c},y_{c}),nₘₐₓ(x_{c}y_{c}), mₘᵢₙ(x_{c},y_{c}),mₘₐₓ(x_{c},y_{c})}^{T}. (Eq. 10)

Values x_{c} are equal to (W−S+D) and (−S−D) for the right and left sides respectively. Values y_{c} are changing according to the position of a walking/standing person. It is desirable to limit the sectors of target tracking to those between the beams starting at point O and passing through the four corners of the vehicle on the right and left sides (depicted as dot-dashed lines in FIG. 1 and FIG. 2), so that coordinate pairs x_{c},y_{c} lie within the above sectors. The minimal and maximal φ angles for these sectors are defined as follows:

Right: {φₘᵢₙ=ATAN2(W−S,B); φₘₐₓ=ATAN2(W−S, B−L)}

Left: {φₘᵢₙ=ATAN2(−S,B−L); φₘₐₓ=ATAN2(−S,B)} (Eq. 11)

Accordingly, the minimal and maximal values for y_{c} based on expressions from (Eq. 5) and (Eq. 11) are:

Right: {y_{c max}=(W−S)cot φₘᵢₙ; y_{c min}=(W−S)cot φₘₐₓ}

Left: {y_{c min}=−S cot φₘᵢₙ; y_{c max}=−S cot φₘₐₓ }. (Eq. 12)

Now, having defined the maximal and minimal values for y_{c}, one can determine FOVs. Thus, running values y_{c} between the limits from (Eq. 12) on both sides of the car and calculating every time angles φ and θ, using (Eq. 7)-(Eq. 9) with due account of (Eq. 5), (Eq. 6) and (Eq. 9), one obtains the desired FOVs as two curved bands on the right and left sides of the video frame having the forms such as those depicted in FIG. 4 in white transparent color and superimposed on a black-and-white version of the equivalent color image in FIG. 4.

As it can be seen from FIG. 4, the generated FOVs are slightly different from the actual fields of view of a car when considering the decreasing of the side windows vertical sizes to the front and rear ends of a car.

Suspicious Behavior Identification Based on Hidden Markov Models

Source image data frames have huge dimensionality so the first operation is preferably dimensionality reduction which is achieved by feature extraction. The latter is preferably invariant to translation, rotation and scaling. Moment invariants (i.e., Hu moment invariants) are often used as such features.

These invariants have been constructed of moments of up to the third order:

φ₁=μ₂₀+μ₀₂,

φ₂=(μ₂₀+μ₀₂)²+4μ₁₁²,

φ₃=(μ₃₀−3μ₁₂)²+(3μ₂₁−μ₀₃)²,

φ₄=(μ₃₀ +μ₁₂)²+(μ₂₁+μ₀₃)²,

φ₅=(μ₃₀−3μ₁₂)(μ₃₀+μ₁₂)[(μ₃₀+μ₁₂)²−3(μ₂₁+μ₀₃)²]+(3μ₂₁−μ₀₃)(μ₂₁+μ₀₃)[3(μ₃₀+μ₁₂)²−(μ₂₁+μ₀₃)²],

φ₆=(μ₂₀−μ₀₂)[(μ₃₀+μ₁₂)²−(μ₂₁+μ₀₃)²]+4μ₁₁(μ₃₀+μ₁₂)(μ₂₁+μ₀₃),

φ₇=(3μ₂₁−μ₀₃)(μ₃₀μ₁₂)[(μ₃₀+μ₁₂)²−3(μ₂₁+∥₀₃)²]−(μ₃₀−3μ₁₂)(μ₂₁+μ₀₃)[3(μ₃₀+μ₁₂)²−(μ₂₁+μ₀₃)²] (Eq. 13)

where central moments μₘₙ are defined as

$${μ}_{mn} = {\int }_{- ∞}^{∞} {\int }_{- ∞}^{∞} {( x - {x}_{c} )}^{m} {( y - {y}_{c} )}^{n} I ( x , y ) d x d y . \qquad ( Eq . 14 )$$

I(x,y) is an image of an object of interest and (x_{c},y_{c}) are centroid coordinates of I(x,y). Equations (Eq. 13) and (Eq. 14) are thus rewritten for discrete coordinates x,y.

Thus, invariants {φₖ}, k=1,2 . . . 7, as defined in (Eq. 13) may be used to present any two-dimensional object including a human shape. Calculation of moments μₘₙ from (Eq. 14) for a human shape is simplified if it is first binarized.

Below, invariants {φₖ} are considered as components of vector \vec{q}ₜ where the time index t is proportional to the video frame number.

The HMM approach can be generally characterized as follows: The current context C covers I behaviors Dᵢ (action classes) each having Mᵢ states where i=1,2, . . . I. Every particular behavior Dᵢ at every moment t is represented by a three-tuple (index t is omitted):

Λᵢ≡(Aᵢ,Bᵢ,πᵢ) (Eq. 15)

where Aᵢ≡{aₘₙⁱ} is the state transition probability distribution, every value aₘₙⁱ denoting the probability of transition from state m to state n ((1≦m, n≦Mᵢ); Bᵢ≡{bₘⁱ(\vec{q}ₜ)} is the observation (feature vector) probability distribution, where bₘⁱ(\vec{q}ₜ) is the probability of observing feature vector \vec{q}ₜ in state m; πᵢ≡{π_{q}ⁱ} is the initial (prior) state distribution having

$${\sum }_{q = 1}^{{M}_{i}} {π}_{q}^{i} = 1.$$

(Below, superscript i is omitted where it doesn't cause ambiguity.)

In the learning phase, the algorithm learns the initial HMM parameters for each action class from a set of image training data (e.g. separately provided image data in the form of predetermined motion sequences of human subjects or actors). The number of HMM states in each experiment is typically determined empirically so that each state presents some characteristic phase in the action. For example, a four-state HMM can be used to adequately capture different human body movements in an image such as the different feet/leg positions on an image during a walk/run cycle. The definition of initial probabilities from Tᵢ, Bᵢ, πᵢ involves statistical processing of those vectors {right arrow over (\tilde{q}ₜ for which state m is known (learning vectors). For instance, if the normal distribution is suggested for bₘⁱ({right arrow over (\tilde{q}ₜ), then only parameters \vec{μ}ₜ and Σₜ (vector of means and covariance matrix) for vectors {right arrow over (\tilde{q} are are to be estimated. Later, these parameters are re-estimated to better present HMMs. This is preferably done based on the Baum-Welch method, which is equivalent to the expectation-modification (EM) approach, resulting in an updated HMM Λ̅ᵢ for every ith behavior. The EM-iterations are continued until parameters of Λ̅ᵢ converge.

When the probe (to be recognized) sequence Q≡{\vec{q}ₜ}, t=t₁,t₂, . . . t_{N}; (N is the number of frames) has been acquired the learned classifier selects the best behavior Dᵢ based on the maximum of the likelihood function as:

$$i = arg \{ {max}_{j} [ P ( Q \vert {\overline{Λ}}_{j} ) ] \} , \qquad ( Eq . 16 )$$

where probability P(Q| Λ̅ⱼ) is calculated using the Forward-Backward Procedure, which makes feasible obtaining P(Q| Λ̅ⱼ) as the direct method of its computation requires a huge number of calculations. Other criteria such as maximum of a posteriori probability (MAP) are also applicable for behavior recognition using HMM.

Motion Saliency Detection

The motion saliency detection of the invention is based on the image processing of “difference frames”, i.e., a series of two or more images in the form of image data frames received from an electronic imager or a computer memory or the like.

Difference frames are obtained by sequentially subtracting a first source image data frame from its successor second source image data frame. The difference frames are then binarized, that is, “absolutizing” the pixel difference values and thresholding them using a predefined threshold value to generate image based pixel sets or “blobs” (i.e., contiguous, related pixel groups having one or more predetermined sets or characteristics such as intensity or color in common) for further analysis and processing.

For instance, assuming a vehicle is immobile when perimeter surveillance is performed, only those areas where there is movement between frames is highlighted in the form of white blobs on a black background in the binarized image. In this manner, an object or its continuous contour can be identified.

In applications using images of human subjects, residual blobs on the difference frames featured clusters of small blobs rather than larger solid blobs, each having sizes commensurate with human body images. The invention identifies these clusters of blobs and “grows” these blob clusters (combines into one blob) to restore the shapes of moving objects.

To grow multiple, combined image blobs concurrently, one aspect of the invention utilizes the “maximum difference” analysis method comprising finding pixel clusters with a predetermined number (here six) of the largest blobs on a frame.

Prior art image processing algorithms such as K-mean or ISODATA algorithms don't permit the ordering of cluster members (blobs) by size which is important for this application. Further, prior art image processing methods involve multiple iterative calculations that are very sensitive to initial values and the K-mean algorithm method assumes that the number of clusters is known a priori; none of which limitations restrict the instant invention.

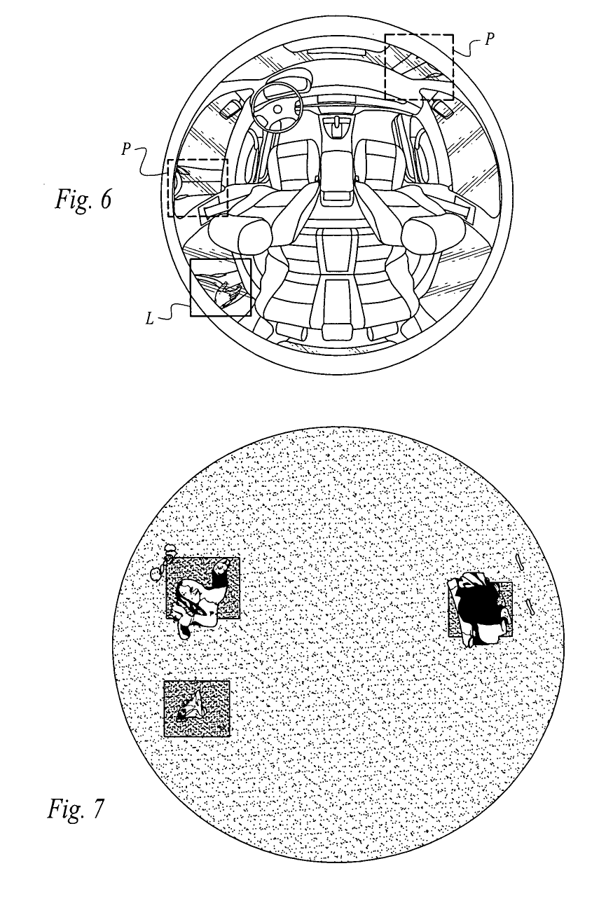

Referring to FIG. 5 and FIG. 6, and as further discussed below, exemplar source frames (FIG. 5) and difference frames (FIG. 6) respectively, have the differences depicted as bright white blobs and were. obtained for a frame set featuring three moving human subjects.

Irvine Sensors Corp., assignee of the instant application has generated a set difference frames using the Reichardt algorithm as known to those skilled in the art of image processing, but the Reichardt algorithm generated results that proved inferior (residual blobs were noise-cluttered and had insufficient size and consistency) to mere frame subtraction of the instant invention.

To partially restore the shapes of targets and identify motion saliency areas or regions, a “blob growing” image processing method is used herein. This method generally comprises two stages, that is, each stage comprises substantially similar steps but is accomplished in the horizontal and vertical directions respectively. The blob growing steps within each of the vertical blob growing stages comprise:

1. Connected components algorithm (CCA) calculations (four-connectedness in the exemplar embodiment) are run on every difference frame with horizontal/vertical “cords” (i.e., strings of successive pixels in one line/column inscribed into a blob),

2. A region of interest or “ROI” (as defined in the Photogrammetric Model discussion) was selected containing a predetermined number (a system parameter) of the largest blobs in a cluster,

3. All blobs covered by the chosen ROI were connected to each other by horizontal/vertical strings to form a “combined (summary) blob” including the original and “completed” pixels.

In FIG. 6, the “completed” pixels are shown in “low grey” and the selected ROIs are depicted in “high grey”. Thus, results from the above processing are the “motion saliency ROIs” (their center-of-mass and corner coordinates are preferably calculated as described in the Photogrammetric Model section).

Hazardous Movement Detection

Hazardous movements (on the part of humans) around a car may assume different forms such as moving back and forth, “loitering” etc. near the vehicle when the person's position (the Y coordinate on FIG. 1) might fluctuate around some point. These movements differ definitely from just passing by a car when the person's Y coordinate is changing monotonically with a considerable (as compared to “fidgeting” and “loitering”) constant speed.

In terms of our ROIs, this can be formalized as “smooth” (low speed) fluctuation of an ROI Y-coordinate. Another condition to be satisfied too is that the summary blob covers a significant part of the ROI (high blob-to-ROI area ratio). This provides for discarding false targets caused by such factors as tree leaves movement, reflections from car side mirrors or intrinsic camera noise.

Thus, the system continuously follows the current ROI Y-coordinate and calculates continuously its derivative and, at the same time, estimates the blob ROI coverage. These data are accumulated, and after a certain period of time (a system parameter of several seconds) if both the derivative absolute value stays lower than a certain threshold, and the blob-to-ROI area ratio stays higher than another threshold (both thresholds are system parameters), a warning flag is raised meaning that the target makes hazardous movements.

Suspicious Behavior Identification

The invention comprises at least two approaches for suspicious behavior identification: 1) a simple approach based on analysis of blobs' ROI coverage and speed value, and, 2) a more sophisticated approach based on Hidden Markov Models (HMM) used successfully for identifying attributes of human behavior.

The following considerations underlie the first approach: Suspicious movements (on the part of human subjects) in the proximity of a vehicle assume different forms and positions such as moving back and forth, “loitering” etc. near the vehicle when the person's position (the Y coordinate on FIG. 1) fluctuates around a point.

The above examples of human movements differ substantially from a person who is merely passing by a car when the non-suspicious person's Y coordinate is changing monotonically with a relatively considerable (as compared to “loitering”) constant speed. (Loitering is understood here as a situation when a person or group remains in a controlled area for a prolonged period of time and moving in a random pattern.)

In terms of ROIs, loitering is formalized as a “smooth” (low speed) fluctuation of an ROI Y-coordinate. Another condition to be satisfied for both loitering and walking is where the summary blob covers a significant part of the ROI (high blob-to-ROI area ratio). This permits discarding false targets caused by such factors as tree leaf movement, reflections from car side mirrors or intrinsic camera noise.

The system continuously follows the current ROI Y-coordinate and calculates continuously its derivative and, at the same time, estimates the blob ROI coverage. These data are accumulated, and after a predetermined period of time (a system parameter of, for instance, several seconds) if both the derivative absolute value stays lower than a predetermined threshold and the blob-to-ROI area ratio stays higher than a predetermined threshold (both thresholds are system parameters), a signal is generated indicating the target has made suspicious movements.

The HMM approach implies first feature extraction and then building the HMM itself.

### Preferred Embodiment of the Invention

One embodiment of the invention comprises software running the behavior identification algorithm on a suitable FPGA-based or DSP-based system in cooperation with a PixeLINK™ PL-B776 color MV Camera (CMOS, optical format 1/2″) with a resolution of 2048 x 1536 pixels and maximum frame rate 12.5 fps, and a Fujinon FE185C046HA-1 Fisheye Lens (for optical format 1/2″, C-mount). In an alternative embodiment, a personal computer or suitable image processing means may be used to run the algorithm of the invention.

Mounting means such as a mounting bar is provided to hold the camera with the lens at a predetermined location in the interior of a vehicle.

The mounting bar with the camera fixed at its mid-point was set up in the middle of, in the illustrated example, a BMW X5's open sunroof so that the camera views the lower hemisphere including the automobile interior volume and the exterior perimeter space of the vehicle through the vehicle side windows. Again, FIG. 1 shows the general geometry of the orientation of the preferred embodiment.

The operation of the invention discussed below assumes three AVI files have been acquired by the above system.

In the discussed embodiment, AVI-files are “unwrapped” into three sequences of BMP-files.

The acquired color image files are transformed into equivalent black-and-white versions, and a suspicious behavior identification algorithm is run as described above. In the example, all three image sequences contained both walking and loitering. The latter included movements such as “shifting feet” and “peeping” into the vehicle interior. In this illustration, all of the movements discussed were performed by amateur actors moving about the exterior of the subject vehicle.

The ROIs indicated by the system are highlighted on the resulting images in the form of rectangles identified as two white boxes in FIG. 7 for targets featuring persons just passing by the car, and as a black box in FIG. 7 for targets featuring individuals making “suspicious” movements.

As an example, FIG. 7 shows ROIs covering three human subjects: two of them (in the middle on the left and in the upper right corner) just passing the car, therefore, they are highlighted by white boxes designated as “P”, and the third subject (in the lower left corner) is “loitering” before moving, so he is highlighted by a black box designated as “L”.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood. as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may .be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

I claim:

1. An intelligent imaging device comprising
A 360-degree view, fish-eye lens electronic imaging system for acquiring an image in a predetermined range of the electromagnetic spectrum from the interior of a vehicle through at least one vehicle window and for generating image data frames from the image,
image processing means for receiving and processing the image data frames wherein the image processing means comprises an algorithm for generating a predetermined output when a predetermined data pattern is identified from the image data frames.

2. A method for identifying a predetermined human behavior comprising:
acquiring a first source image data frame and a second source image data frame,
subtracting the first source image data frame from the second source image data frame to define a difference frame,
binarizing the difference frame using a predetermined threshold value to generate at least one image blob,
identifying motion saliency from a sequence of binarized difference frames by using a blob growing process.

3. The method of claim 2 further comprising the steps of calculating Hu moment invariants on salient blobs for dimensionality reduction.

4. The method of claim 3 further comprising using a Hidden Markov Model for classification of blob time histories based on at least one Hu moment invariant.
